(19) United States
(12) Patent Application Publication
(10) Pub. No.: US 2026/0089037 A1
(43) Pub. Date: Mar. 26, 2026

(54) SEMICONDUCTOR DEVICE AND TRANSMISSION DEVICE

(71) Applicant: Kioxia Corporation, Tokyo (JP)

(72) Inventors: Tomohiro TAMURA, Ota Tokyo (JP); Takayuki IWAI, Setagaya Tokyo (JP)

(21) Appl. No.: 19/080,206

(22) Filed: Mar. 14, 2025

(30) Foreign Application Priority Data
Sep. 20, 2024 (JP) 2024-164320

(51) Int. Cl. H04L 25/02; H04L 25/03; H04L 25/49

(52) U.S. Cl. CPC H04L 25/0278; H04L 25/0276; H04L 25/03057; H04L 25/03885; H04L 25/4906; H04L 2025/0349

(57) ABSTRACT

Reliable high-speed serial transmission is performed. A semiconductor device includes a first circuit, a second circuit, and a third circuit. The first circuit is configured to receive a first signal, which is a differential parallel signal, and output a second signal, which is a differential serial signal, based on the first signal. The second circuit is configured to adjust an output impedance of an output node of the first circuit. The third circuit is configured to vary a power supply voltage that is supplied to at least a part of the first circuit in accordance with an adjustment of the output impedance by the second circuit.

### CROSS-REFERENCE TO RELATED APPLICATIONS

This application is based upon and claims the benefit of priority from Japanese Patent Application No. 2024-164320, filed Sep. 20, 2024, the entire contents of which are incorporated herein by reference.

### FIELD

Embodiments described herein relate generally to a semiconductor device and a transmission device.

### BACKGROUND

M-PHY has been attracting attention as a circuit for high-speed serial transmission inside electronic equipment such as smartphones. The M-PHY is a standard established by a mobile industry processor interface (MIPI) Alliance. In the M-PHY standard, the amplitude level of an output signal is limited in order to operate with low power consumption. Furthermore, according to the M-PHY standard, signals are transmitted using DC coupling, so a common mode voltage of the output signal is important. In other words, in a communication standard for transmitting signals using DC coupling, the common mode voltage of the output signal is important.

When there is variation in the output impedance value of the transmission device, the amplitude and common mode voltage of the output signal will vary. As a countermeasure for this, for example, when a circuit for adjusting the output impedance value is provided in the transmission device, the amplitude of the output signal is decreased. Therefore, there is a risk that such a countermeasure may not satisfy the specification of the M-PHY for output amplitude, output impedance, and common mode voltage.

### BRIEF DESCRIPTION OF THE DRAWINGS

FIG. 1 is a block diagram schematically showing a configuration of a communication system according to a first embodiment.

FIG. 2 is a block diagram schematically showing a configuration of a transmission device according to the first embodiment.

FIG. 3 is a block diagram showing an example of an internal configuration of a parallel in serial out (PISO) circuit.

FIG. 4 is a block diagram showing an internal configuration of a source serial termination (SST) circuit.

FIG. 5 is a circuit diagram showing an example of an internal configuration of one SST unit and one impedance adjustment circuit.

FIG. 6 is a diagram showing the corresponding relation between an enable signal and an adjustment code input to an SST driver and the impedance adjustment circuit in FIG. 5 and an operation state of the impedance adjustment circuit.

FIG. 7 is a diagram showing the correspondence relation between a plurality of impedance adjustment circuits and respective bits of adjustment codes according to the first embodiment.

FIG. 8 is a flowchart showing an example of a processing operation of the communications system.

FIG. 9 is a diagram showing an example of a lookup table showing the correspondence relation between the adjustment code and a power supply voltage of the SST circuit.

FIG. 10 is a voltage waveform diagram showing an output amplitude value and a common mode voltage of a serial signal output by the transmission device according to the first embodiment.

FIG. 11 is a circuit diagram of a main part of a transmission device according to a comparative example.

FIG. 12 is a voltage waveform diagram showing an output amplitude value and a common mode voltage of a serial signal output by the transmission device according to the comparative example.

FIG. 13 is a circuit diagram showing an example of an internal configuration of one SST driver and one impedance adjustment circuit in a transmission device according to a second embodiment.

FIG. 14 is a diagram showing the correspondence relation between an enable signal and an adjustment code input to the SST driver and the impedance adjustment circuit of FIG. 13 and an operation state of the impedance adjustment circuit.

FIG. 15 is a circuit diagram showing an example of an internal configuration of one SST driver and one impedance adjustment circuit in a transmission device according to a third embodiment.

FIG. 16 is a diagram showing the correspondence relation between an enable signal and an adjustment code input to the SST driver and the impedance adjustment circuit in FIG. 15 and an operation state of the impedance adjustment circuit.

FIG. 17 is a diagram showing the correspondence relation between a plurality of impedance adjustment circuits and respective bits of the adjustment code according to the third embodiment.

FIG. 18 is a circuit diagram showing an example of an internal configuration of one SST driver and one impedance adjustment circuit in a transmission device according to a modification of the third embodiment.

FIG. 19 is a diagram showing the correspondence relation between an enable signal and an adjustment code input to the SST driver and the impedance adjustment circuit of FIG. 18 and an operation state of the impedance adjustment circuit.

### DETAILED DESCRIPTION

An object of one or more embodiments of the present invention is to provide a semiconductor device and a transmission device that are capable of performing high-speed serial transmission with high reliability.

In general, according to one or more embodiments, a semiconductor device includes a first circuit, a second circuit, and a third circuit. The first circuit is configured to receive a first signal, which is a differential parallel signal, and output a second signal, which is a differential serial signal, based on the first signal. The second circuit is configured to adjust an output impedance of an output node of the first circuit. The third circuit is configured to vary a power supply voltage that is supplied to at least a part of the first circuit in accordance with an adjustment of the output impedance by the second circuit.

Embodiments of a semiconductor device and a transmission device will be described hereinafter with reference to the drawings. The following description will be made while focusing on main components of the semiconductor device and the transmission device, but the semiconductor device and the transmission device may have components and functions that are not shown or described. The following description does not exclude components and functions that are not shown or described.

### First Embodiment

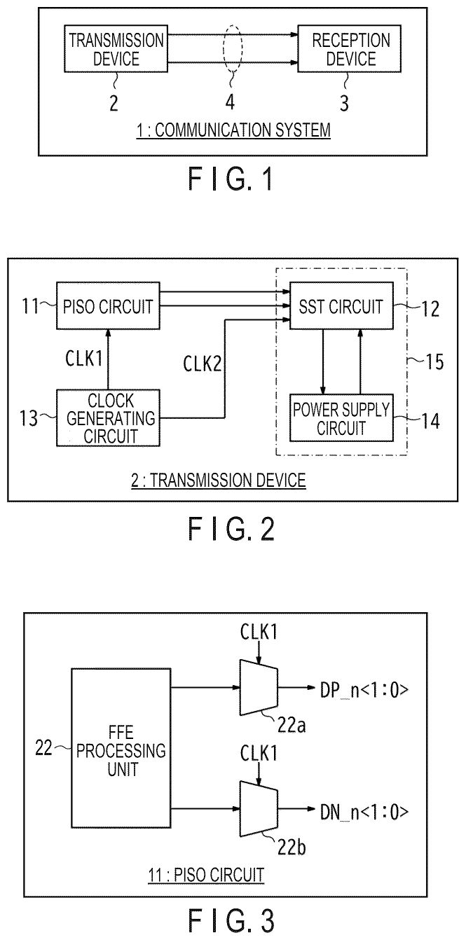

FIG. 1 is a block diagram schematically showing a configuration of a communication system 1 according to a first embodiment. The communication system 1 in FIG. 1 includes a transmission device 2, a reception device 3, and a differential transmission line 4. The transmission device 2 and the reception device 3 perform high-speed serial transmission via the differential transmission line 4. More specifically, the transmission device 2 outputs a differential serial signal to the differential transmission line 4. The transmission device 2 has a function of converting a parallel signal into a differential serial signal. The differential serial signal output by the transmission device 2 is, for example, a signal encoded in a predetermined format. Although any suitable encoding format is acceptable, the present disclosure describes an example in which a binary signal is encoded by pulse amplitude modulation (PAM).

The reception device 3 receives the differential serial signal from the transmission device 2 and decodes it back into an original binary signal. The length of the differential transmission line 4 does not matter. The transmission device 2 and the reception device 3 may be implemented on separate semiconductor chips or may be implemented in the same semiconductor package.

FIG. 2 is a block diagram schematically showing a configuration of the transmission device 2 according to the first embodiment. The transmitting device 2 in FIG. 2 has a parallel in serial out (PISO) circuit 11, a clock generating circuit 13, and a semiconductor device 15. The semiconductor device 15 includes a source serial termination (SST) circuit 12, and a power supply circuit 14. The SST circuit 12 and the power supply circuit 14 may be implemented on the same semiconductor chip. At least one of the PISO circuit 11 and the clock generating circuit 13 may be implemented on this semiconductor chip, or they may be implemented on separate semiconductor devices.

The PISO circuit 11 outputs a first signal which is a parallel signal or a serial signal. For example, the PISO circuit 11 outputs a first signal obtained by converting a parallel signal into a serial signal. Also, for example, the PISO circuit 11 converts a fourth signal being a parallel signal of a first bit string into a first signal being a parallel signal of a second bit string having a smaller number of bits than the first bit string, and outputs the converted signal.

The clock generating circuit 13 generates a first clock signal CLK1 that is used to synchronize the first signal output from the PISO circuit 11, and a second clock signal CLK2 that is used to synchronize the second signal output from the SST circuit 12. The second clock signal CLK2 is, for example, a frequency-divided signal of the first clock signal CLK1.

The SST circuit 12 outputs a second signal, which is a serial signal based on the first signal output from the PISO circuit 11. The second signal is, for example, a differential serial signal. In the present disclosure, the SST circuit 12 may be referred to as a first circuit, and the PISO circuit 11 may be referred to as a conversion circuit.

As described below, the SST circuit 12 has a plurality of SST units, and each SST unit has a serial signal generating circuit and an SST driver. The serial signal generating circuit outputs an output signal obtained by processing the first signal. The SST driver generates and outputs a second signal based on the output signal of the serial signal generating circuit.

The power supply circuit 14 controls a power supply voltage of at least a part of the circuit portion of the SST circuit 12 in accordance with the adjustment of the output impedance of the SST circuit 12. Specifically, the power supply circuit 14 controls the power supply voltage of the SST driver in the SST circuit 12 in accordance with an adjustment result of the output impedance. The power supply circuit 14 may be, for example, a low drop output (LDO) regulator. The LDO regulator can operate even when the voltage difference between an input voltage and an output voltage is small, can restrain heat generation, and has excellent power efficiency. In the present disclosure, the power supply circuit 14 may be referred to as a third circuit.

The power supply circuit 14 controls the power supply voltage of at least a part of the circuit portion of the SST circuit 12 (e.g., the SST driver), for example, such that the output impedance of the SST circuit 12, and the amplitude value and common mode voltage of the serial signal output from the SST circuit 12 meet predetermined standards.

FIG. 3 is a block diagram showing an example of an internal configuration of the PISO circuit 11. The PISO circuit 11 in FIG. 3 has a feed forward equalizer (FFE) processing unit 21, and two multiplexers 22a and 22b.

The FFE processing unit 21 performs FFE processing for increasing the gain of the Nyquist frequency related to the data transmission band when converting the fourth signal, which is a parallel signal, into the first signal. The FFE processing is processing for compensating for the rounding of the waveform of the differential serial signal output from the transmission device 2, inter-symbol interference (ISI), etc.

The PISO circuit 11 outputs a first signal that has been subjected to the FFE processing by the FFE processing unit 21. The first signal is, for example, a differential parallel signal or serial signal. In the present disclosure, an example in which the PISO circuit 11 outputs a first signal that is a differential parallel signal will be mainly described. For example, the PISO circuit 11 outputs M pairs of differential first signals DP_n<1:0> and DN_n<1:0>. Here, M represents any integer equal to or more than 2. The PISO circuit 11 outputs M pairs of first signals DP_n<0> and DN_n<0> at the same timing in synchronization with the first clock signal CLK1, and then outputs M pairs of DP_n<1> and DN_n<1> at a timing which is shifted by half a cycle from the first clock signal CLK1.

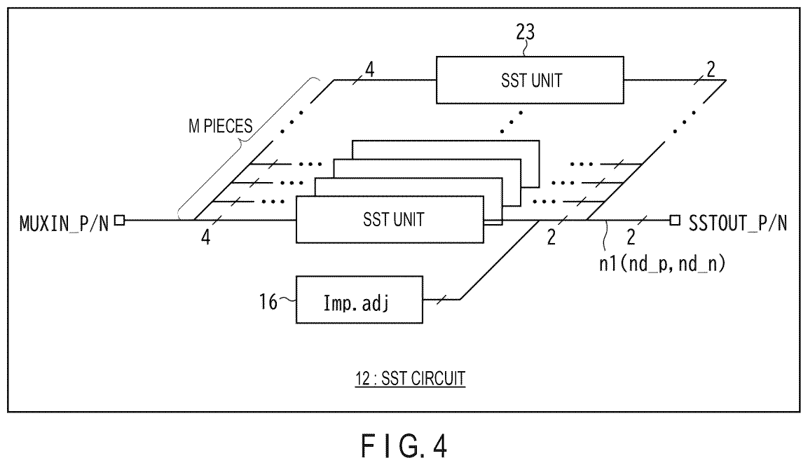

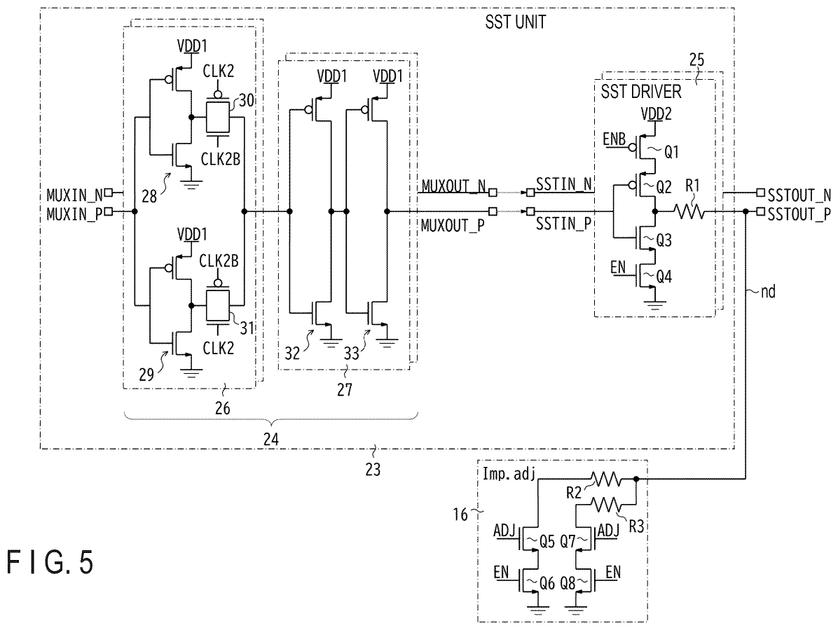

FIG. 4 is a block diagram showing an internal configuration of the SST circuit 12. The SST circuit 12 includes M SST units 23 connected in parallel and a plurality of impedance adjustment circuits (Imp. adj) 16. The M SST units 23 are respectively associated with M pairs of differential first signals DP_n<1:0> and DN_n<1:0> output from the PISO circuit 11. In other words, input signals MUXIN_P and MUXIN_N of each SST unit 23 are the corresponding pair of the first signals DP_n<1:0> and DN_n<1:0> output from the PISO circuit 11. In the present disclosure, the SST unit 23 may be referred to as a fifth circuit.

Each SST unit 23 outputs differential signals OUT_P and OUT_N obtained by converting the corresponding pair of first signals DP_n<1:0> and DN_n<1:0> into serial signals.

Output nodes nd of the M SST units 23 are connected to one another. In the present disclosure, a node at which the output nodes nd of the M SST units 23 are mutually connected is referred to as a common connection node n1. More precisely, an output node nd_p for outputting one signals OUT_P out of the differential signals OUT_P and OUT_N output from the respective SST units 23 are connected to one another, and an output node nd_n for outputting the other signals OUT_N are connected to one another. In the present disclosure, the output nodes nd_p and nd_n may be expressed as the output nodes nd (or the common connection node n1).

When the PISO circuit 11 outputs a PAM4 signal, any four first signals DP_n<1:0> and DN_n<1:0> are output in parallel. These four first signals DP_n<1:0> and DN_n<1:0> are input to a corresponding one of the SST units 23. Each of the SST units 23 generates signals OUT_P and OUT_N which are differential serial signals. The voltage levels of the signals OUT_P and OUT_N generated in parallel by the respective SST units 23 may differ from one another.

However, no problem occurs even when the respective output nodes nd of the SST units 23 are connected to the common connection node n1.

In this way, the SST circuit 12 outputs the differential second signals SSTOUT_P and SSTOUT_N obtained by subjecting the M differential signals OUT_P and OUT_N generated in parallel by the M SST units 23 to wired-OR at the common connection node n1.

A plurality of impedance adjustment circuits 16 are connected to the common connection node n1. The number of impedance adjustment circuits 16 connected to the common connection node n1 is arbitrary. The plurality of impedance adjustment circuits 16 have the same circuit configuration, and have the same output impedance.

The impedance adjustment circuit 16 adjusts the output impedance of the common connection node n1 of the SST driver (SST circuit 12). In the present disclosure, the impedance adjustment circuit 16 may be referred to as a second circuit, a fourth circuit, or Imp. adj. Also, in the present disclosure, an example will be described in which the output impedance adjusted by the impedance adjustment circuit 16 is the output resistance.

Each impedance adjustment circuit 16 is, for example, a circuit that terminates the common connection node n1 at a power supply voltage node or a ground voltage node. The power supply voltage node is a node for supplying a power supply potential for some circuit of the SST circuit 12. The ground voltage node is a node for supplying a reference potential when the SST circuit 12 operates. The impedance adjustment circuit 16 adjusts, for example, the output resistance between the common connection node n1 of the SST circuit 12 and the power supply voltage node or the ground voltage node.

As described below, some impedance adjustment circuits 16 out of the plurality of impedance adjustment circuits 16 are connected to the common connection node n1 of the SST circuit 12. As the number of impedance adjustment circuits 16 connected to the common connection node n1 of the SST circuit 12 increases, the output resistance of the SST circuit 12 decreases, so that the amplitude of the second signals OUT_P and OUT_N decreases.

All of the M SST units 23 have a common circuit configuration. FIG. 5 is a circuit diagram showing an example of an internal configuration of one SST unit 23 and one impedance adjustment circuit 16. As shown in FIG. 5, each of the M SST units 23 includes a serial signal generating circuit 24 and an SST driver 25. The respective output nodes nd of the SST units 23 are all connected to the common connection node n1 of the SST circuit 12. Furthermore, a plurality of impedance adjustment circuits 16 are connected to the common connection node n1 of the SST circuit 12. Actually, although omitted in FIG. 5, the plurality of impedance adjustment circuits 16 are connected to the output node nd_p connected to the common connection node n1_p for outputting the second signal SSTOUT_P and the output node nd_n connected to the common connection node n1_n for outputting the second signal SSTOUT_N. In the present disclosure, the serial signal generating circuit 24 may be referred to as a sixth circuit, and the SST driver 25 may be referred to as a seventh circuit.

The serial signal generating circuit 24 includes two pairs of multiplexers 26 and two pairs of buffer circuits 27. The multiplexer 26 of each pair receives the first signal DP_n<1:0> or DN_n<1:0> of the corresponding pair output from the PISO circuit 11 as an input signal MUXIN_P or MUXIN_N. The multiplexer 26 and the buffer circuit 27 of one pair converts the first signal DP_n<1:0> into a third signal MUXOUT_P which is a serial signal, and outputs it. The multiplexer 26 and the buffer circuit 27 of the other pair converts the first signal DN_n<1:0> into a third signal MUXOUT_N which is a serial signal, and outputs it. The third signals MUXOUT_P and MUXOUT_N are output in parallel at the same timing, and input to the SST driver 25. In FIG. 5, the input signals SSTIN_P and SSTIN_N of the SST driver 25 are the third signals MUXOUT_P and MUXOUT_N output from the serial signal generating circuit 24.

The multiplexer 26 of one pair includes a first inverter 28, a second inverter 29, a first transfer gate 30, and a second transfer gate 31. The first inverter 28 and the second inverter 29 invert and output the first signal DP_n<1:0>. The first transfer gate 30 passes the inverted output signal of the first inverter 28 when the second clock signal CLK2 is at a high level, and blocks the inverted output signal of the first inverter 28 when the second clock signal CLK2 is at a low level, for example. The second transfer gate 31 passes the inverted output signal of the second inverter 29 when the second clock signal CLK2 is at a low level, and blocks the inverted output signal of the second inverter 29 when the second clock signal CLK2 is at a high level, for example. The multiplexer 26 of the other pair has the same configuration as the multiplexer 26 of one pair, and performs the same operation.

Both the buffer circuit 27 of one pair and the buffer circuit 27 of the other pair have a third inverter 32 and a fourth inverter 33 connected in cascade. The buffer circuit 27 of one pair buffers and outputs the serial signal output from the multiplexer 26 of one pair. The buffer circuit 27 of the other pair buffers and outputs the serial signal output from the multiplexer 26 of the other pair. As a result, the buffer circuit 27 outputs the third signals MUXOUT_P and MUXOUT_N which are serial signals.

The SST driver 25 has two PMOS transistors Q1 and Q2 and two NMOS transistors Q3 and Q4 that are cascade-connected between the power supply voltage node to which a power supply voltage VDD2 is supplied and the ground voltage node. An enable signal ENB is input to the gate of the transistor Q1. The gates of the transistors Q2 and Q3 are connected to an input node of the SST driver 25. The drains of the transistors Q2 and Q3 are connected to one end of a resistor R1, and an output node nd (common connection node n1) of the SST driver 25 is connected to the other end of the resistor R1. An enable signal EN is input to the gate of the transistor Q4. In the present disclosure, the SST driver 25 may be referred to as a sixth circuit.

In the present disclosure, the “B” at the end of a signal name means that it is a logical inversion. For example, the inverted signal of the enable signal EN is an enable signal ENB.

The resistance values of the resistors R1 connected to the respective output nodes n of the M SST drivers 25 included in the M SST units 23 are not necessarily the same, and can take any of a plurality of resistance values.

When the enable signal EN is at a high level (the enable signal ENB is at a low level), the SST driver 25 turns on both transistors Q1 and Q4, and inverts and outputs the serial signal output from the serial signal generating circuit 24. The output node nd of each SST driver 25 is connected to the common connection node n1 of the SST circuit 12 and the resistor R1, so that the amplitude of the serial signal output from the SST circuit 12 changes depending on the value of the resistor R1. In other words, by adjusting the resistance value of the resistor R1 connected to the output node nd of each SST driver 25, it is possible to control the signal amplitudes of the second signals SSTOUT_P and SSTOUT_N which are serial signals.

A predetermined number of impedance adjustment circuits 16 out of a plurality of (for example, 15) impedance adjustment circuits 16 are connected to the common connection node n1 which is the output node of the SST circuit 12. Depending on how many impedance adjustment circuits 16 are connected to the output node n1 of the SST circuit 12, the signal amplitudes of the second signals SSTOUT_P and SSTOUT_N output from the SST circuit 12 change.

The impedance adjustment circuit 16 shown in FIG. 5 includes resistors R2 and R3 whose one ends are connected to the common connection node n1 of the SST circuit 12, two NMOS transistors Q5 and Q6 which are cascade-connected between the other end of the resistor R2 and the ground voltage node, and two NMOS transistors Q7 and Q8 which are cascade-connected between the other end of the resistor R3 and the ground voltage node. An adjustment code ADJ is input to both gates of the transistors Q5 and Q7, and an enable signal EN is input to both gates of the transistors Q6 and Q8.

As described below, the number of impedance adjustment circuits 16 selected varies depending on the bit value of the adjustment code ADJ. Each of the plurality of impedance adjustment circuits 16 has resistors R2 and R3 having the same resistance value, but the number of impedance adjustment circuits 16 connected to the common connection node n1 of the SST circuit 12 is changed depending on the bit value of the adjustment code ADJ, thereby controlling switching of the output resistance of the common connection node n1. The present disclosure describes an example in which the number of impedance adjustment circuits 16 connected to the common connection node n1 of the SST circuit 12 is increased when the bit on the MSB side of the adjustment code ADJ is equal to 1.

The adjustment code ADJ is a bit string signal containing a plurality of bits. When a certain bit of the adjustment code ADJ and the enable signal EN are both at a high level, the NMOS transistors Q5, Q6, Q7, and Q8 in the corresponding impedance adjustment circuit 16 are turned on. The other end of the resistor R2 and the other end of the resistor R3 in the corresponding impedance adjustment circuit 16 are both connected to the ground voltage node, which makes the impedance adjustment circuit 16 equivalent to a circuit in which the resistors R2 and R3 are connected in parallel between the output node nd of the SST driver 25 and the ground voltage node. The impedance adjustment circuit 16 is connected between the output node nd of the SST driver 25 and the ground voltage node. In other words, the impedance adjustment circuit 16 is a GND-terminated circuit.

When the adjustment code ADJ has a-bits, this may be expressed as ADJ<a−1:0> in the present disclosure. In this case, (2^{(a+1)}−1) impedance adjustment circuits 16 are provided. Therefore, (2^{(a+1)}−1) impedance adjustment circuits 16 at maximum are connected to the common connection node n1 of the SST circuit 12.

In each of the plurality of (for example, 15) impedance adjustment circuits 16, the transistors Q5 and Q7 are turned on or off according to the corresponding adjustment code. Depending on the number of impedance adjustment circuits 16 in which the transistors Q5 and Q7 are turned on, the output resistance of each SST driver 25 changes, and the output resistance of the SST circuit 12 also changes.

In this way, when the transistors Q5 to Q8 are turned on, the impedance adjustment circuit 16 shown in FIG. 5 becomes a GND-terminated circuit connected between the output node nd of the SST driver 25 (the common connection node n1 of the SST circuit 12) and the ground voltage node.

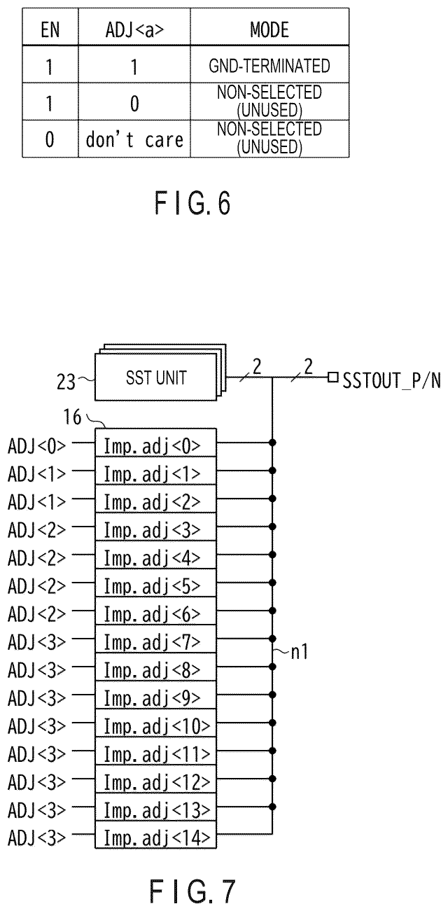

FIG. 6 is a diagram showing the correspondence relation between the enable signal EN and the adjustment code ADJ<a> input to the SST driver 25 and the impedance adjustment circuit 16 in FIG. 5 and an operation state of the impedance adjustment circuit 16. Here, “a” represents the bit of the adjustment code ADJ, and “a” is an arbitrary integer from 0 to 3, for example. When the enable signal EN is at a high level (the enable signal ENB is at a low level), the SST driver 25 and the impedance adjustment circuit 16 are in an enabled state. On the other hand, when the enable signal EN is at a low level, regardless of the value of each bit of the adjustment code ADJ<a>, the impedance adjustment circuit 16 is cut off from the output node nd of the SST driver 25, and falls into a non-selected (unused) state.

When the adjustment code ADJ<a> is set to a high level in a state where the enable signal EN is at a high level, the impedance adjustment circuit 16 becomes a circuit that connects the GND-terminated output resistance to the output node nd of the SST driver 25 (common connection node n1 of the SST circuit 12). In this case, the output impedance is equal to a value corresponding to the resistance value of the parallel-connected resistors R2 and R3.

When the adjustment code ADJ<a> is set to a low level in a state where the enable signal EN is at a high level, the transistors Q5 and Q7 are turned off, so that the impedance adjustment circuit 16 is cut off from the output node nd of the SST driver 25 (common connection node n1 of the SST circuit 12). In other words, in this case, the impedance adjustment circuit 16 falls into a non-selected (unused) state.

FIG. 7 is a diagram showing the correspondence relation between the plurality of impedance adjustment circuits 16 and the respective bits of the adjustment code ADJ according to the first embodiment. FIG. 7 shows an example in which the adjustment code ADJ has 3 bits, that is, 15 impedance adjustment circuits 16 are provided.

As shown in FIG. 7, all the output nodes nd of the M SST units 23 are connected to the common connection node n1 of the SST circuit 12. When the adjustment code ADJ<0> is at a high level, the output of one impedance adjustment circuit Imp. adj<0> is connected to the common connection node n1 of the SST circuit 12. When the adjustment code ADJ<1> is at a high level, the outputs of two impedance adjustment circuits Imp. adj<1> to <2> are connected to the common connection node n1 of the SST circuit 12. When the adjustment code ADJ<2> is at a high level, the outputs of four impedance adjustment circuits Imp. adj<3> to <6> are connected to the common connection node n1 of the SST circuit 12. When the adjustment code ADJ<3> is at a high level, the outputs of the eight impedance adjustment circuits Imp. adj<7> to <14> are connected to the common connection node n1 of the SST circuit 12.

As described above, the number of impedance adjustment circuits 16 connected to the common connection node n1 of the SST circuit 12 varies for each bit of the adjustment code ADJ. It is noted that FIG. 7 is only an example, and the correspondence relation between each bit of the adjustment code ADJ and the number of impedance adjustment circuits 16 connected to the common connection node n1 of the SST circuit 12 may be changed in various ways.

The power supply circuit 14 controls the level of the power supply voltage VDD2 of the SST driver 25 according to the adjustment code ADJ. On the other hand, a power supply voltage VDD1 of the serial signal generating circuit 24 in each SST unit 23 is set at a fixed level regardless of the adjustment code ADJ.

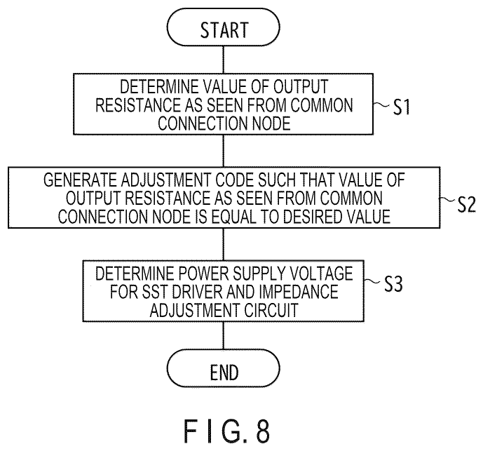

The communication system 1 in FIG. 1 includes, for example, a transmission device 2 including a controller (SoC: System on a Chip) and a reception device 3 including a storage device (not shown) such as a NAND flash memory. FIG. 8 is a flowchart showing an example of the processing operation of the communication system 1.

First, the controller (not shown) of the transmission device 2 determines an output resistance value which is seen from the common connection node n1 of the SST circuit 12 (S1). The controller of the transmission device 2 uses a resistance variation value sent from the reception device 3 to determine the output resistance value seen from the common connection node n1 of the SST circuit 12 from the output resistance of the transmission device 2, the amplitude value of the serial signal received by the reception device 3, a common mode voltage of the serial signal, etc. For example, the above-mentioned output resistance value is determined such that the amplitude value of the serial signal received by the reception device 3 is equal to a desired value. Since the amplitude value of the serial signal received by the reception device 3 is also affected by the common mode voltage of the serial signal, the above-mentioned output resistance value is determined while considering the common mode voltage, etc.

Next, the controller of the transmission device 2 generates the adjustment code ADJ such that the value of the output resistance seen from the common connection node n1 of the SST circuit 12 is equal to a desired value (S2).

Next, the controller of the transmission device 2 or the power supply circuit 14 determines the power supply voltage VDD2 of the SST driver 25 so as to compensate for the rounding of the waveform of the serial signal received by the reception device 3, ISI, etc., (S3).

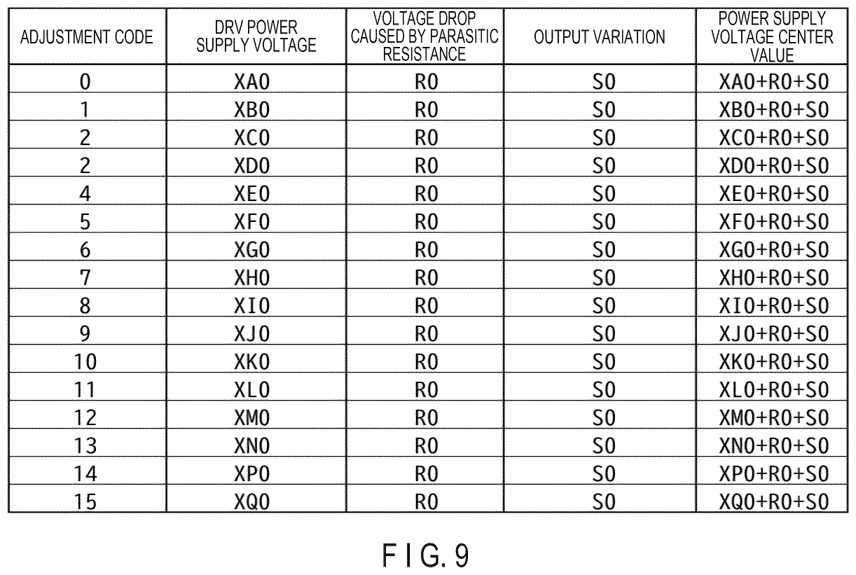

FIG. 9 is a diagram showing an example of a look-up table showing the correspondence relation between the adjustment code ADJ and the power supply voltage VDD2 of the SST circuit 12. By providing the power supply circuit 14 with a storage unit for storing the look-up table of FIG. 9, the power supply circuit 14 can quickly determine the power supply voltage VDD2 of the SST circuit 12 based on the adjustment code ADJ from the controller.

In the lookup table in FIG. 9, registered is the correspondence relation among the adjustment code ADJ, the desired power supply voltage (DRV power supply voltage) VDD2, the amount of voltage drop caused by a parasitic resistance of the power supply line, the output variation of the power supply voltage generated by the power supply circuit 14, and the center value of the power supply voltage output by the power supply circuit 14. Since the power supply voltage of the power supply circuit 14 varies due to manufacturing variations and the power supply line has parasitic resistance, in order to supply the desired power supply voltage VDD2 to the SST driver 25, it is necessary to generate a power supply voltage having an optimal value in the power supply circuit 14. By preparing the lookup table in FIG. 9 in advance, a power supply voltage having an optimal value that matches the adjustment code ADJ can be generated in the power supply circuit 14.

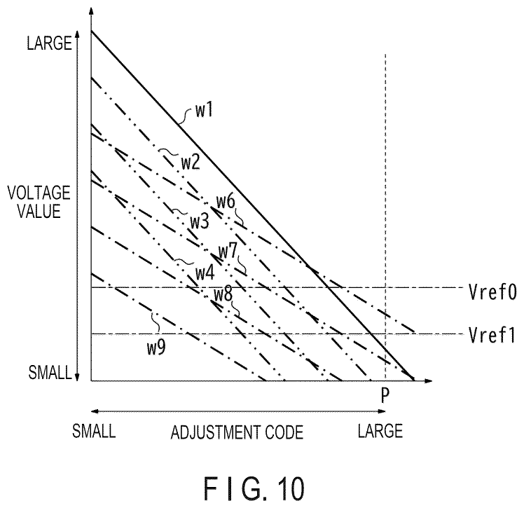

An M-PHY standard specifies the output amplitude, output resistance, and common mode voltage of the serial signal to be transmitted. FIG. 10 is a waveform diagram showing the output amplitude value and common mode voltage of the serial signal output by the transmission device 2 according to the first embodiment. The horizontal axis of FIG. 10 represents the adjustment code ADJ, and the vertical axis thereof represents the voltage value. FIG. 10 shows waveforms w1 to w4 of the common mode voltage corresponding to the power supply voltage VDD2 of the SST driver 25, and waveforms w6 to w9 of the output amplitude value (voltage value) of the serial signal from the SST driver 25. The waveforms w1 to w4 correspond to the waveforms w6 to w9, respectively.

As shown in FIG. 10, the output resistance of the SST driver 25 decreases as the adjustment code ADJ increases, so that the output amplitude value and common mode voltage of the serial signal decrease. In the M-PHY standard, when the adjustment code ADJ is a certain value P, the output amplitude value and common mode voltage value of the serial signal must be within the specification of the M-PHY standard. In FIG. 10, by adjusting the power supply voltage VDD2 of the SST driver 25, the common mode voltage (waveform w1) when the adjustment code ADJ is a certain value P drops below a standard value Vref0 of the common mode voltage, and the output amplitude (waveform w6) of the SST driver 25 can be set to be higher than a standard value Vref1, whereby it is possible to satisfy the specification of the M-PHY standard.

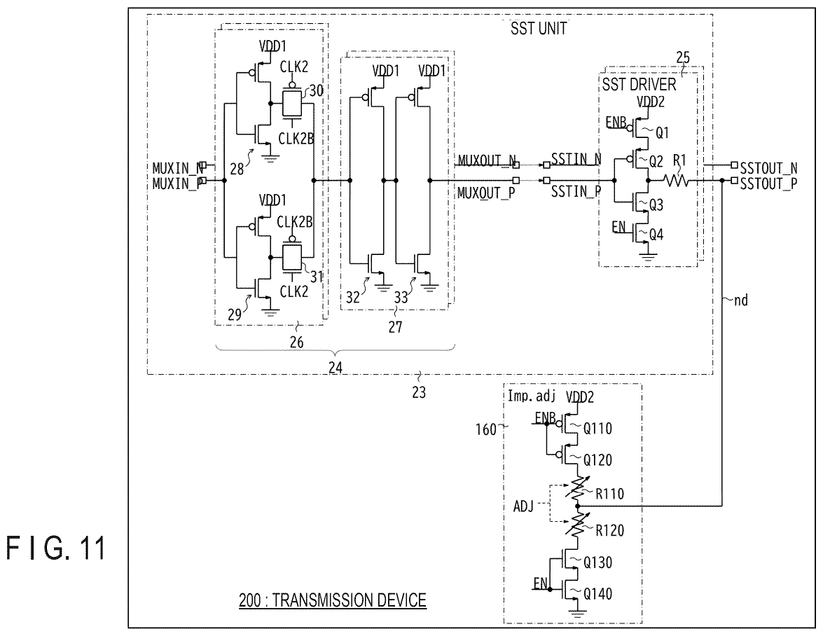

FIG. 11 is a circuit diagram of a portion of a transmission device 200 according to a comparative example. More specifically, FIG. 11 is a circuit diagram showing an example of a circuit configuration of an SST unit 23 and an impedance adjustment circuit 160 according to the comparative example. In FIG. 11, components common to FIG. 5 are given the same reference symbols, and the following description will focus on the differences.

The circuit configuration of the SST unit 23 in FIG. 11 is the same as that of the SST unit 23 in FIG. 5.

The impedance adjustment circuit 160 according to the comparative example shown in FIG. 11 has a circuit configuration different from that of the impedance adjustment circuit 16 shown in FIG. 5. The impedance adjustment circuit 160 shown in FIG. 11 includes resistors R110 and R120 whose one ends are connected to the output node nd of the SST driver 25, two PMOS transistors Q110 and Q120 which are cascade-connected between the other end of the resistor R110 and the node to which the power supply voltage VDD2 is supplied, and two NMOS transistors Q130 and Q140 which are cascade-connected between the other end of the resistor R120 and the ground voltage node. The resistors R110 and R120 are trimmed according to the adjustment code ADJ, whereby the resistance values of the resistors R110 and R120 are variably adjusted. An enable signal ENB is input to both gates of the two PMOS transistors Q110 and Q120, and an enable signal EN is input to both gates of the two NMOS transistors Q130 and Q140. In this way, the impedance adjustment circuit 160 according to the comparative example is a circuit that terminates at the power supply voltage VDD2 and terminates at the ground voltage. In the comparative example, since the power supply voltage VDD2 of the SST driver 25 is fixed, even when the resistors R110 and R120 of the impedance adjustment circuit 160 are adjusted according to the adjustment code ADJ, it is impossible to vary the common mode voltage.

Furthermore, the power supply voltage VDD2 of the SST driver 25 according to the comparative example has a constant voltage level that does not depend on the adjustment code. In other words, in the comparative example, once the power supply voltage VDD2 of the SST driver 25 is set, the power supply voltage VDD2 cannot be changed thereafter.

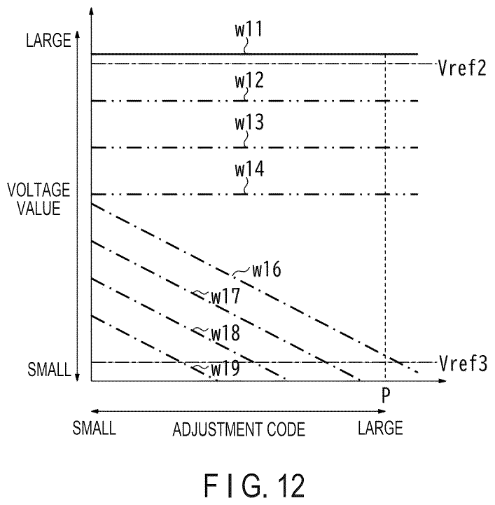

FIG. 12 is a waveform diagram showing the output amplitude value and common mode voltage of the serial signal output by the transmission device 200 according to the comparative example. FIG. 12 shows waveforms w11 to w14 of the common mode voltage according to the power supply voltage VDD2 of the SST driver 25, and waveforms w16 to w19 of the output amplitude value (voltage value) of the serial signal from the SST driver 25. The waveforms w11 to w14 correspond to the waveforms w16 to w19, respectively.

As shown in FIG. 12, as the power supply voltage VDD2 of the SST driver 25 increases, the common mode voltage increases, and even when the adjustment code changes, the common mode voltage hardly changes. Therefore, in a case where the adjustment code is the certain value P, even when the output amplitude (waveform w16) of the SST driver 25 can be set to a value larger than a standard value Vref3, the common mode voltage exceeds an upper limit value Vref2 defined by the M-PHY standard, and thus it does not satisfy the specification of the M-PHY standard.

As described above, the first embodiment includes the impedance adjustment circuit 16 that does not terminate at the power supply voltage VDD2 node, but terminates at the ground voltage node, and the power supply voltage VDD2 of the SST driver 25 is variably adjusted according to the adjustment code ADJ, so that the common mode voltage can be lowered as the adjustment code ADJ increases, and it can satisfy the specification of the common mode voltage defined in the M-PHY standard.

Furthermore, in the first embodiment, since the power supply voltage VDD2 of the SST driver 25 is variably controlled according to the adjustment code ADJ, it is possible to optimize the output amplitude value of the serial signal output from the SST circuit 12 even when the adjustment code ADJ increases. Therefore, regardless of the adjustment code ADJ, it is possible to satisfy the specifications of the common mode voltage and the output amplitude value of the serial signal output from the SST circuit 12 defined by the M-PHY standard.

### Second Embodiment

The impedance adjustment circuit 16 according to the first embodiment is terminated at the ground voltage node, but an impedance adjustment circuit 16a according to a second embodiment is terminated at a power supply voltage node. In the present disclosure, termination at a node (power supply voltage node) to which the power supply voltage VDD2 is supplied may be referred to as VDD-termination.

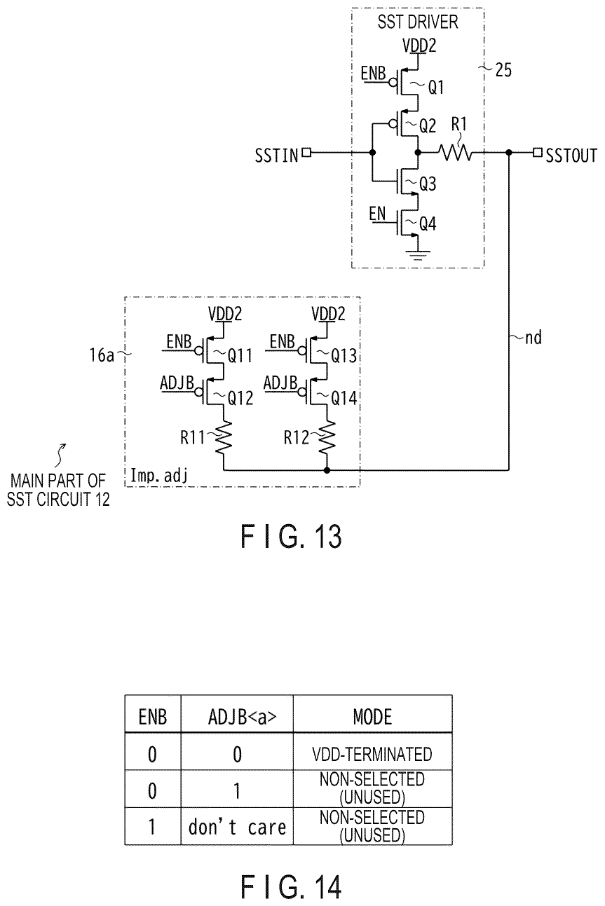

FIG. 13 is a circuit diagram showing an example of an internal configuration of one SST driver 25 and one impedance adjustment circuit 16a in a transmission device 2 according to the second embodiment. A SST circuit 12 according to the second embodiment includes a plurality of impedance adjustment circuits 16a, and M SST drivers 25 each having a circuit configuration similar to that in FIG. 5. FIG. 13 shows one impedance adjustment circuit 16a and one SST driver 25.

The impedance adjustment circuit 16a in FIG. 13 includes resistors R11 and R12 whose one terminals are connected to the output node nd of the SST driver 25 (the common connection node n1 of the SST circuit 12), PMOS transistors Q11 and Q12 which are cascade-connected between the power supply voltage node and the other end of the resistor R11, and PMOS transistors Q13 and Q14 which are cascade-connected between the power supply voltage node and the other end of the resistor R12.

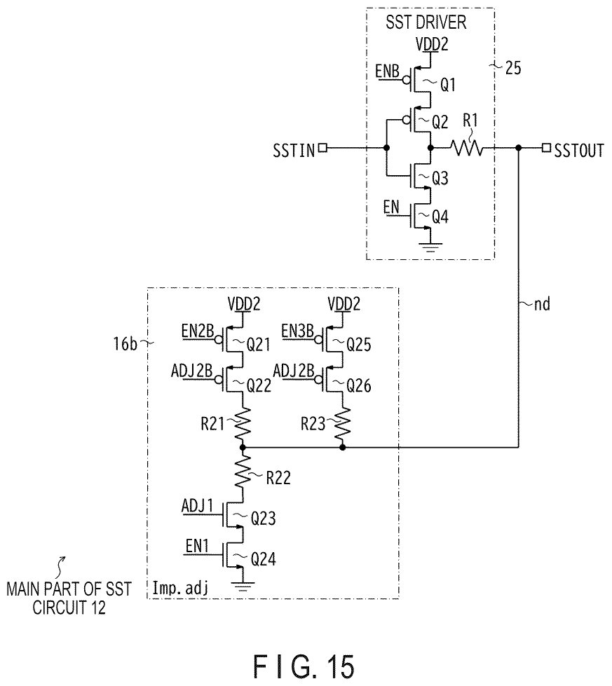

The circuit configuration of the SST driver 25 in FIG. 13 is similar to that of the SST driver 25 in FIG. 5. Although omitted in FIG. 13, the output node of the serial signal generating circuit 24 having a circuit configuration similar to that in FIG. 5 is connected to the input node SSTIN of the SST driver 25, but the illustration of the serial signal generating circuit 24 is omitted in FIG. 15.

An enable signal ENB is input to each gate of the transistors Q11 and Q13. An adjustment code ADJB is input to each gate of the transistors Q12 and Q14. The adjustment code ADJB is an inverted signal of the adjustment code ADJ.

FIG. 14 is a diagram showing the correspondence relation between the enable signal ENB and the adjustment code ADJB<a> input to the SST driver 25 and the impedance adjustment circuit 16a in FIG. 13, and the operation state of the impedance adjustment circuit 16a. Here, “a” is an arbitrary integer from 0 to 3, for example. When the enable signal ENB is at a low level, the SST driver 25 and the impedance adjustment circuit 16a falls into an enabled state. On the other hand, when the enable signal ENB is at a high level, regardless of the value of each bit of the adjustment code ADJB<a>, the impedance adjustment circuit 16a is cut off from the output node nd of the SST driver 25 and falls into a non-selected (unused) state.

When the adjustment code ADJB<a> is set to a low level in a state where the enable signal ENB is at a low level, the impedance adjustment circuit 16a becomes a circuit in which resistors R11 and R12 are connected in parallel between the output node nd of the SST driver 25 (the common connection node n1 of the SST circuit 12) and the power supply voltage node to which the power supply voltage VDD2 is supplied. In this case, the output resistance is a value according to the resistance value of the parallel-connected resistors R11 and R12.

When the adjustment code ADJB<a> is set to a high level in a state where the enable signal ENB is at a low level, the transistors Q12 and Q14 are turned off, so that the impedance adjustment circuit 16a is cut off from the output node nd of the SST driver 25 (the common connection node n1 of the SST circuit 12). In other words, in this case, the impedance adjustment circuit 16a falls into a non-selected state (unused state).

In the SST driver 25 of the second embodiment, the power supply voltage VDD2 is variably controlled according to the adjustment code as in the case of the SST driver 25 in FIG. 5.

As described above, the second embodiment includes an impedance adjustment circuit 16a that does not terminate at the ground voltage node, but terminates at the power supply voltage node, and since the power supply voltage VDD2 of the SST driver 25 is variably adjusted according to the adjustment codes ADJ and ADJB, so that the common mode voltage can be increased as the adjustment code increases, and the specification of the common mode voltage defined in the M-PHY standard can be satisfied.

Furthermore, in the second embodiment, since the power supply voltage VDD2 of the SST driver 25 is variably controlled according to the adjustment codes ADJ and ADJB, even when the adjustment codes ADJ and ADJB are large, the output amplitude value of the serial signal output from the SST circuit 12 can be optimized. Therefore, regardless of the adjustment codes ADJ and ADJB, the specifications of the common mode voltage and the output amplitude value of the serial signal output from the SST circuit 12 defined by the M-PHY standard can be satisfied.

### Third Embodiment

In a third embodiment, it can be alternatively selected according to the adjustment code as to whether the impedance adjustment circuit 16 is VDD-terminated and GND-terminated, or GND-terminated.

FIG. 15 is a circuit diagram showing an example of an internal configuration of one SST driver 25 and one impedance adjustment circuit 16b in a transmission device 2 according to the third embodiment. The SST circuit 12 according to the third embodiment includes a plurality of impedance adjustment circuits 16b and M SST drivers 25 having a circuit configuration similar to that of FIG. 5. FIG. 15 shows one impedance adjustment circuit 16b and one SST driver 25.

The impedance adjustment circuit 16b in FIG. 15 has a circuit configuration obtained by combining a part of the impedance adjustment circuit 16 in FIG. 5 and the impedance adjustment circuit 16a in FIG. 13. Specifically, the impedance adjustment circuit 16b in FIG. 15 includes resistors R21, R22, and R23 whose one ends are connected to the output node nd of the SST driver 25 (common connection node n1 of the SST circuit 12), NMOS transistors Q21 and Q22 that are cascade-connected between the power supply voltage node and the other end of the resistor R21, NMOS transistors Q23 and Q24 that are cascade-connected between the other end of the resistor R22 and the ground voltage node, and NMOS transistors Q25 and Q26 that are cascade-connected between the power supply voltage node and the other end of the resistor R23.

An adjustment code ADJ1 is input to the gate of the transistor Q23, and an enable signal EN1 is input to the gate of the transistor Q24. An enable signal EN2B is input to the gate of the transistor Q21, an enable signal EN3B is input to the gate of the transistor Q25, and an adjustment code ADJ2B is input to each of the gates of the transistors Q22 and Q26. The adjustment code ADJ1 and the adjustment code ADJ2B are signals independent of each other. The enable signal EN1, the enable signal EN2B, and the enable signal EN3B are signals independent of one another.

The circuit configuration of the SST driver 25 in FIG. 15 is similar to that of the SST driver 25 in FIG. 5. Although omitted in FIG. 15, the output node of the serial signal generating circuit 24 having a circuit configuration similar to that in FIG. 5 is connected to the input node SSTIN of the SST driver 25, but the illustration of the serial signal generating circuit 24 is omitted in FIG. 15.

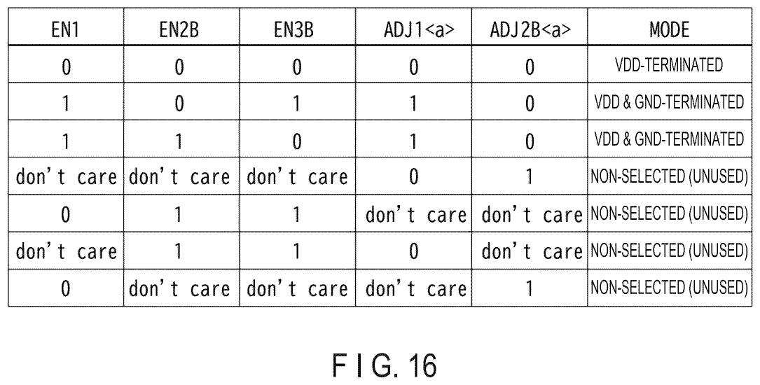

FIG. 16 is a diagram showing the corresponding relation between the enable signals EN1, EN2B, and EN3B, and the adjustment codes ADJ1<a> and ADJ2B<a> input to the SST driver 25 and the impedance adjustment circuit 16b in FIG. 15, and the operation state of the impedance adjustment circuit 16b. Here, “a” is any integer from 0 to 3.

When the enable signals EN1, EN2B, and EN3B are at a low level and the adjustment codes ADJ1 and ADJ2B are both at a low level, the impedance adjustment circuit 16b is VDD-terminated, and an output resistance corresponding to the resistance value of the parallel-connected resistors R21 and R23 is connected between the output node nd of the SST driver 25 (the common connection node n1 of the SST circuit 12) and the power supply voltage node.

When the enable signal EN1 is at a high level, the enable signal EN2B is at a low level, the enable signal EN3B is at a high level (or the enable signal EN1 is at a high level, the enable signal EN2B is at a high level, and the enable signal EN3B is at a low level), the adjustment code ADJ1 is at a high level, and the adjustment code ADJ2B is at a low level, the impedance adjustment circuit 16b is VDD-terminated and GND-terminated, an output resistance corresponding to the resistance value of the resistor R21 (or R23) between the output node nd of the SST driver 25 (the common connection node n1 of the SST circuit 12) and the power supply voltage node is connected, and an output resistance corresponding to the resistance value of the resistor R22 between the output node nd of the SST driver 25 (the common connection node n1 of the SST circuit 12) and the ground voltage node is connected.

The impedance adjustment circuit 16b falls into a non-selected (unused) state when the adjustment code ADJ1 is at a low level and the adjustment code ADJ2B is at a high level. Furthermore, the impedance adjustment circuit 16b falls into a non-selected (unused) state when the enable signal EN1 is at a low level and the enable signals EN2B and EN3B are at a high level. Furthermore, the impedance adjustment circuit 16b falls into a non-selected (unused) state when the enable signals EN2B and EN3B are at a high level and the adjustment code ADJ1 is at a low level. Still furthermore, the impedance adjustment circuit 16b falls into a non-selected (unused) state when the enable signal EN1 is at a low level and the adjustment code ADJ2B is at a high level.

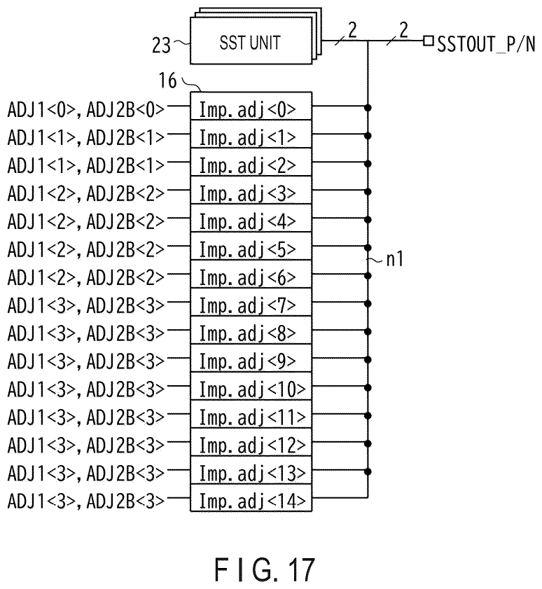

FIG. 17 is a diagram showing the corresponding relation between the plural impedance adjustment circuits 16b and the respective bits of the adjustment code ADJ according to the third embodiment. As shown in FIG. 17, the output nodes nd of the M SST units 23 are all connected to the common connection node n1 of the SST circuit 12. When the adjustment code ADJ1<0> is at a high level and the adjustment code ADJ2B<0> is at a low level, the output of one impedance adjustment circuit Imp. adj<0> is connected to the common connection node n1 of the SST circuit 12. When the adjustment code ADJ1<1> is at a high level and the adjustment code ADJ2B<1> is at a low level, the outputs of two impedance adjustment circuits Imp. adj<1> to <2> are connected to the common connection node n1 of the SST circuit 12. When the adjustment code ADJ1<2> is at a high level and the adjustment code ADJ2B<2> is at a low level, the outputs of four impedance adjustment circuits Imp. adj<3> to <6> are connected to the common connection node n1 of the SST circuit 12. When the adjustment code ADJ1<3> is at a high level and the adjustment code ADJ2B<3> is at a low level, the outputs of the eight impedance adjustment circuits Imp. adj<7> to <14> are connected to the common connection node n1 of the SST circuit 12.

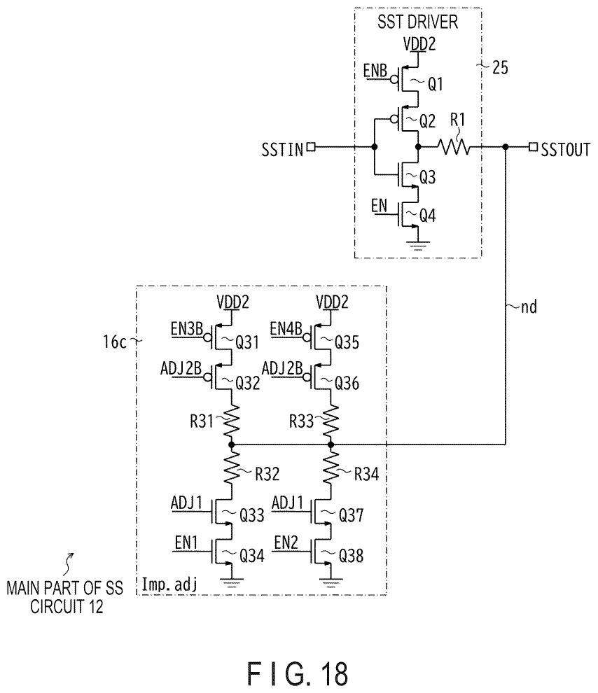

FIG. 18 is a circuit diagram showing an example of an internal configuration of one SST driver 25 and one impedance adjustment circuit 16c in a transmission device 2 according to a modification of the third embodiment. FIG. 18 shows one impedance adjustment circuit 16c and one SST driver 25 included in an SST circuit 12 according to the modification. The circuit configuration of the impedance adjustment circuit 16c in FIG. 18 is similar to that of the impedance adjustment circuit 16b in FIG. 15. The impedance adjustment circuit 16c in FIG. 18 includes resistors R31, R32, R33, and R34 whose one ends are connected to the output node nd of the SST driver 25 (common connection node n1 of the SST circuit), PMOS transistors Q31 and Q32 that are cascade-connected between the power supply voltage node and the other end of the resistor R31, NMOS transistors Q33 and Q34 that are cascade-connected between the other end of the resistor R32 and the ground voltage node, PMOS transistors Q35 and Q36 that are cascade-connected between the power supply voltage node and the other end of the resistor R33, and NMOS transistors Q37 and Q38 that are cascade-connected between the other end of the resistor R34 and the ground voltage node.

Some of the signals input to the gates of these transistors Q31 to Q38 are different between the circuit configurations shown in FIG. 18 and FIG. 15. In the impedance adjustment circuit 16c in FIG. 18, an enable signal EN3B is input to the gate of the transistor Q31, an adjustment code ADJ2B is input to the gate of the transistor Q32, an adjustment code ADJ1 is input to the gate of the transistor Q33, and an enable signal EN1 is input to the gate of the transistor Q34. Furthermore, an enable signal EN4B is input to the gate of the transistor Q35, an adjustment code ADJ2B is input to the gate of the transistor Q36, an adjustment code ADJ1 is input to the gate of the transistor Q37, and an enable signal EN2 is input to the gate of the transistor Q38.

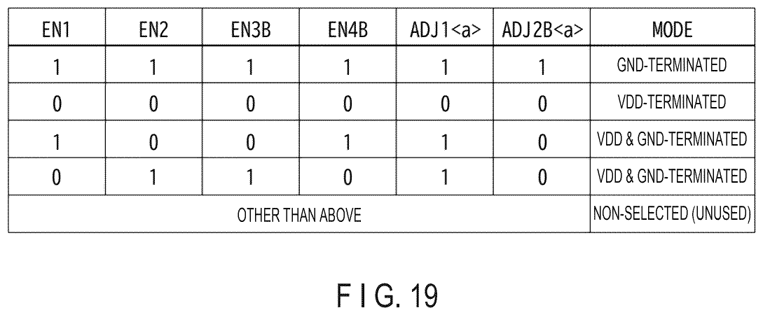

FIG. 19 shows the correspondence relation of the enable signals EN1, EN2, EN3B, and EN4B and the bit values of the adjustment codes ADJ1<a> and ADJ2B<a> (for example, “a” is 0 to 3) input to the SST driver 25 and the impedance adjustment circuit 16c in FIG. 18, and the operation state of the impedance adjustment circuit 16c.

When the enable signals EN1, EN2, EN3B, and EN4B are all at a high level and the adjustment codes ADJ1<a> and ADJ2B<a> are all at a high level, the transistors Q33, Q34, Q37, and Q38 are turned on, and the transistors Q31, Q35, Q32, and Q36 are turned off, so that the impedance adjustment circuit 16c is GND-terminated.

When the enable signals EN1, EN2, EN3B, and EN4B are all at a low level and the adjustment codes ADJ1<a> and ADJ2B<a> are all at a low level, the transistors Q31, Q32, Q35, and Q36 are turned on, and the transistors Q33, Q34, Q37, and Q38 are turned off, so that the impedance adjustment circuit 16c is VDD-terminated.

When the enable signals EN1 and EN4B are at a high level, the enable signals EN2 and EN3B are at a low level, the adjustment code ADJ1<a> is at a high level, and the adjustment code ADJ2B<a> is at a low level, the transistors Q31 to Q34 are all turned on, so that the impedance adjustment circuit 16c is VDD-terminated and GND-terminated.

When the enable signals EN1 and EN4B are at a low level, the enable signals EN2 and EN3B are at a high level, the adjustment code ADJ1<a> is at a high level, and the adjustment code ADJ2B<a> is at a low level, the transistors Q35 to Q38 are all turned on, so that the impedance adjustment circuit 16c is VDD-terminated and GND-terminated.

When the enable signals EN1, EN2, EN3B, 3N4B, the adjustment codes ADJ1 and ADJ2B satisfy logic other than the above logic, the impedance adjustment circuit 16c falls into a non-selected (unused) state.

Furthermore, the output resistance when all the transistors Q31 to Q38 in the impedance adjustment circuit 16c are turned on has a different value from that of the output resistance when only one pair of transistors (Q31, Q32) and (Q35, Q36) is turned on and only one pair of transistors (Q33, Q34) and (Q37, Q38) is turned on. Therefore, the logic of the enable signals EN1, EN2, EN3B, and EN4B and the adjustment codes ADJ1<a> and ADJ2B<a> are controlled such that all the transistors Q31 to Q38 in the impedance adjustment circuit 16c are not turned on.

As described above, in the third embodiment, by switching the logic of the enable signals EN1, EN2, EN3B, and EN4B and the adjustment codes ADJ1<a> and ADJ2B<a>, it is possible to perform a switching operation as to whether the impedance adjustment circuit 16c is VDD-terminated and GND-terminated or the impedance adjustment circuit 16c is VDD(GND)-terminated. Therefore, it is possible to adjust the common mode voltage to a common mode voltage that is most easily receivable by the reception device 3.

The aspect of the present disclosure is not limited to the individual embodiments described above, but include various modifications that a person skilled in the art can conceive, and the effects of the present disclosure are not limited to the above. In other words, various additions, modifications, and partial deletions are possible within the conceptual idea and gist of the present disclosure derived from the contents defined in the claims and their equivalents.

What is claimed is:

1. A semiconductor device comprising:
a first circuit configured to receive a first signal, which is a differential parallel signal, and output a second signal, which is a differential serial signal, based on the first signal;
a second circuit configured to adjust an output impedance of an output node of the first circuit; and
a third circuit configured to vary a power supply voltage that is supplied to at least a part of the first circuit in accordance with an adjustment of the output impedance by the second circuit.

2. The semiconductor device according to claim 1, wherein the third circuit is configured to vary the power supply voltage such that a value of the output impedance, an amplitude value of the second signal, and a common mode voltage of the second signal satisfy a predetermined standard.

3. The semiconductor device according to claim 1, wherein the second circuit includes a circuit configured to terminate at a power supply voltage node.

4. The semiconductor device according to claim 1, wherein the second circuit includes a circuit configured to terminate at a ground voltage node.

5. The semiconductor device according to claim 1, wherein the second circuit is configured to adjust the output impedance based on an adjustment code, and the third circuit is configured to vary the power supply voltage based on the adjustment code.

6. The semiconductor device according to claim 5, wherein
the second circuit has a plurality of fourth circuits that are connected in parallel and have a common circuit configuration, and
the second circuit is configured to control, based on the adjustment code, whether or not to connect each of output nodes of the plurality of fourth circuits to the output node of the first circuit, to adjust the output impedance.

7. The semiconductor device according to claim 6, wherein each of the plurality of fourth circuits has a resistor, a first transistor configured to be turned on or off according to a corresponding bit of the adjustment code, and a second transistor configured to switch whether or not a corresponding one of the fourth circuits is enabled.

8. The semiconductor device according to claim 6, wherein the first circuit includes a plurality of fifth circuits to which the first signal is input, the second signal being output from a common connection node that connects each of output nodes of the plurality of fifth circuits to each of output nodes of the plurality of fourth circuits.

9. A transmission device comprising:
the semiconductor device according to claim 1; and
a conversion circuit configured to output the first signal to the semiconductor device.

10. The transmission device according to claim 9, wherein the conversion circuit is configured to convert a fourth signal, which is a parallel signal of a first bit string into the first signal, which is a differential parallel signal of a second bit string having a smaller number of bits than the first bit string, and output the first signal.

11. A semiconductor device comprising:
a source serial termination (SST) circuit configured to receive a first signal, which is a differential parallel signal, and output a second signal, which is a differential serial signal, based on the first signal;
an impedance adjustment circuit configured to adjust an output impedance of an output node of the SST circuit; and
a power supply circuit configured to vary a power supply voltage that is supplied to at least a part of the SST circuit in accordance with an adjustment of the output impedance by the impedance adjustment circuit.

12. The semiconductor device according to claim 11, wherein the power supply circuit is configured to vary the power supply voltage such that a value of the output impedance, an amplitude value of the second signal, and a common mode voltage of the second signal satisfy a predetermined standard.

13. The semiconductor device according to claim 11, wherein the impedance adjustment circuit includes a circuit configured to terminate at a power supply voltage node.

14. The semiconductor device according to claim 11, wherein the impedance adjustment circuit includes a circuit configured to terminate at a ground voltage node.

15. The semiconductor device according to claim 11, wherein the impedance adjustment circuit is configured to adjust the output impedance based on an adjustment code, and the power supply circuit is configured to vary the power supply voltage based on the adjustment code.

16. The semiconductor device according to claim 15, wherein
the impedance adjustment circuit has a plurality of sub circuits that are connected in parallel and have a common circuit configuration, and
the impedance adjustment circuit is configured to control, based on the adjustment code, whether or not to connect each of output nodes of the plurality of sub circuits to the output node of the SST circuit, to adjust the output impedance.

17. The semiconductor device according to claim 16, wherein each of the plurality of sub circuits has a resistor, a first transistor configured to be turned on or off according to a corresponding bit of the adjustment code, and a second transistor configured to switch whether or not a corresponding one of the sub circuits is enabled.

18. The semiconductor device according to claim 16, wherein the SST circuit includes a plurality of SST units to which the first signal is input, the second signal being output from a common connection node that connects each of output nodes of the plurality of SST units to each of output nodes of the plurality of sub circuits.

19. A transmission device comprising:
the semiconductor device according to claim 11; and
a conversion circuit configured to output the first signal to the semiconductor device.

20. The transmission device according to claim 19, wherein the conversion circuit is configured to convert a fourth signal, which is a parallel signal of a first bit string into the first signal, which is a differential parallel signal of a second bit string having a smaller number of bits than the first bit string, and output the first signal.
